(19) United States
(12) Patent Application Publication
(10) Pub. No.: US 2025/0280470 A1
(43) Pub. Date: Sep. 4, 2025

(54) AEROSOL-GENERATING DEVICE AND HEATING STRUCTURE

(71) Applicant: SMOORE INTERNATIONAL HOLDINGS LIMITED, George Town (KY)

(72) Inventors: Guo ZHANG, Shenzhen (CN); Lei MA, Shenzhen (CN); Hongming ZHOU, Shenzhen (CN); Rihong LI, Shenzhen (CN); Xianwu DU, Shenzhen (CN); Yaobin HU, Shenzhen (CN); Qingchen CHU, Shenzhen (CN)

(21) Appl. No.: 19/211,083

(22) Filed: May 16, 2025

Related U.S. Application Data
(63) Continuation of application No. PCT/CN2023/114118, filed on Aug. 21, 2023.

(30) Foreign Application Priority Data
Nov. 17, 2022 (CN) 202211442109.1

(51) Int. Cl. H05B 3/00; A24F 40/46

(52) U.S. Cl. CPC H05B 3/0038; A24F 40/46; H05B 2203/002; H05B 2203/037

(57) ABSTRACT

A heating structure includes: a heating portion; and two conductive portions. The heating portion has a spiral structure and is formed by winding at least one heating element, the at least one heating element including a heating substrate for generating heat in an electrified state, an infrared radiation layer being provided on an outer surface of the heating substrate so as to radiate infrared light waves. The heating portion includes a first end and a second end provided opposite to the first end. The two conductive portions are connected to the first end and the second end of the heating portion, respectively, and extend in a same direction.

### CROSS-REFERENCE TO PRIOR APPLICATION

This application is a continuation of International Patent Application No. PCT/CN2023/114118, filed on Aug. 21, 2023, which claims priority to Chinese Patent Application No. 202211442109.1, filed on Nov. 17, 2022. The entire disclosure of both applications is hereby incorporated by reference herein.

### FIELD

The present disclosure relates to the field of heat not burning atomization and, more particularly, to an aerosol-generating device and a heating structure.

### BACKGROUND

In the field of heat not burning (HNB) atomization, generally, heating methods such as central heater heating or peripheral heater heating are adopted. It is a common practice that the heating element generates heat, and then the heat is directly transferred to an aerosol-generating substrate through heat conduction, and the substrate is generally atomized at temperatures within 350° C. A disadvantage of this way of heating is that the heating element transfers heat directly or indirectly via a solid material to the aerosol-generating substrate, which requires that an operating temperature of the heating element remain relatively low, which would otherwise cause the substrate to overheat and adversely affect the vaping experience.

In the central heating structure disclosed in the related art, the heating element is generally in the shape of an elongated column or a flat sheet; the operating temperature of the heating element is generally about 400° C., resulting in low heat conduction efficiency and limited improvement in the vaping experience. Moreover, the heating structure with a maximum operating temperature higher than 400° C. has not been studied yet.

### SUMMARY

In an embodiment, the present invention provides a heating structure, comprising: a heating portion; and two conductive portions, wherein the heating portion has a spiral structure and is formed by winding at least one heating element, the at least one heating element comprises a heating substrate configured to generate heat in an electrified state, an infrared radiation layer being provided on an outer surface of the heating substrate and configured to radiate infrared light waves, wherein the heating portion comprises a first end and a second end provided opposite to the first end, and wherein the two conductive portions are connected to the first end and the second end of the heating portion, respectively, and extend in a same direction.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram showing an aerosol-generating device according to a first embodiment of the present disclosure;

FIG. 2 is a schematic structural diagram showing a heating structure in the aerosol-generating device as shown in FIG. 1;

FIG. 3 is a cross-sectional view of the heating structure as shown in FIG. 2;

FIG. 4 is an exploded view of the heating structure as shown in FIG. 2;

FIG. 5 is a schematic structural diagram showing a heating element of the heating structure as shown in FIG. 4;

FIG. 6 is a transverse cross-sectional view of the heating element as shown in FIG. 5;

FIG. 7 is a schematic structural diagram showing a heating structure in an aerosol-generating device according to a second embodiment of the present disclosure;

FIG. 8 is a cross-sectional view of the heating structure as shown in FIG. 7;

FIG. 9 is an exploded view of the heating structure as shown in FIG. 7;

FIG. 10 is a schematic structural diagram showing a heating structure of an aerosol-generating device according to a third embodiment of the present disclosure;

FIG. 11 is a cross-sectional view of the heating structure as shown in FIG. 10;

FIG. 12 is an exploded view of the heating structure as shown in FIG. 10;

FIG. 13 is a partial schematic structural diagram showing a heating structure in an aerosol-generating device according to a fourth embodiment of the present disclosure;

FIG. 14 is a partial schematic structural diagram showing a heating structure in an aerosol-generating device according to a fifth embodiment of the present disclosure;

FIG. 15 is a schematic structural diagram showing a heating structure in an aerosol-generating device according to a sixth embodiment of the present disclosure; and

FIG. 16 is an exploded view of the heating structure as shown in FIG. 15.

### DETAILED DESCRIPTION

In an embodiment, the present invention provides an improved aerosol-generating device and a heating structure.

In an embodiment, the present invention provides a heating structure including a heating portion and two conductive portions; the heating portion has a spiral structure and is formed by winding at least one heating element, the heating element includes a heating substrate for generating heat in an electrified state, and an infrared radiation layer provided on the outer surface of the heating substrate for radiating infrared light waves; the heating portion includes a first end and a second end provided opposite to the first end; the two conductive portions are connected to the first end and the second end of the heating portion, respectively, and extend in the same direction.

In some embodiments, the heating portion is a double spiral structure.

In some embodiments, the heating portion includes a first heating portion and a second heating portion; one end of the first heating portion and one end of the second heating portion are connected and wound into a double spiral structure; and

the two conductive portions are connected to the other ends of the first heating portion and the second heating portion, respectively.

In some embodiments, the heating portion includes a plurality of spiral sections connected successively.

In some embodiments, radial sizes of the respective spiral sections of the heating portion are equal.

In some embodiments, the radial sizes of the plurality of spiral sections are not completely equal or not equal at all.

In some embodiments, the plurality of spiral sections are configured such that the radial sizes of the spiral sections provided at or near a middle portion are greater than those of the spiral sections provided at or near the two ends.

In some embodiments, the plurality of spiral sections are configured such that the radial sizes of the spiral sections provided at or near the middle portion are smaller than those of the spiral sections provided at or near the two ends.

In some embodiments, the plurality of spiral sections are distributed at equal intervals.

In some embodiments, the plurality of spiral sections are distributed densely and sparsely alternately.

In some embodiments, the plurality of spiral sections are distributed sparsely first and then densely.

In some embodiments, the plurality of spiral sections are distributed densely first and then sparsely.

In some embodiments, the plurality of spiral sections are distributed sparsely first, then densely, and sparsely finally.

In some embodiments, the plurality of spiral sections are distributed densely first, then sparsely, and densely finally.

In some embodiments, the heating element is provided longitudinally, and the first heating portion and the second heating portion are formed by bending.

In some embodiments, the device further includes a support rod, where the support rod partially extends into the heating portion and is insulated from the heating portion for supporting the heating portion.

In some embodiments, the device further includes a base, the tube body is mounted on the base, and the two conductive portions extend out of the base.

In some embodiments, the device further includes a tube body that allows the infrared light wave generated by the heating portion to pass through; where the heating element is provided at least partially spaced apart from the tube body.

In some embodiments, a fixing structure for fixing the heating portion is provided on the tube body.

In some embodiments, the tube body has a hollow tubular shape and is formed with a first accommodating cavity therein for accommodating the heating element.

In some embodiments, the heating elements are spaced apart on a periphery of the tube body, and the tube body is hollow inside and is formed therein with a second accommodating cavity for accommodating an aerosol substrate.

In some embodiments, the tube body includes a first tube body that allows light waves to pass through and a second tube body sleeved over the periphery of the first heating portion;
a spacing is provided between the second tube body and the first tube body, and the spacing forms a first accommodating cavity accommodating the heating portion, and a second accommodating cavity for heating an aerosol-generating substrate is formed inside the first heating portion.

In some embodiments, an air gap is provided between at least a part of the heating element and the inner wall of the second tube body and/or the outer wall of the first tube body.

In some embodiments, the heating element is spaced apart from tube wall of the tube body as a whole.

In some embodiments, the heating element is not provided in direct contact with the tube body.

In some embodiments, the tube wall of the tube body has a thickness of from 0.15 to 0.6 mm.

In some embodiments, a pitch between the tube wall of the tube body and the heating element is from 0.05 to 1 mm.

The present disclosure also contemplates an aerosol-generating device including a heating structure according to the present disclosure.

The aerosol-generating device and the heating structure according to the present disclosure have the following advantageous effects: By winding at least one heating element to form a heating portion having a spiral structure, the heat transfer efficiency of the heating portion may be improved, and the overall reliability of the heating structure may be improved, such that the uniformity of the gap between the heating portion and the tube body may be maintained, and thus a temperature field may be kept uniform.

In addition, by connecting the two conductive portions to the first end and the second end of the heating portion, respectively, and extending in the same direction, an overall assembly process of the heating structure may be simplified; furthermore, an infrared radiation layer is provided on the outer surface of the heating substrate; when the heating substrate generates heat in an electrified state, the heat may excite the infrared radiation layer to radiate an infrared light wave, and the infrared light wave may pass through the tube body to heat the aerosol-generating substrate. Even when the maximum operating temperature of the heating element reaches above 1000° C. (the operating temperature of a conventional HNB heating element generally does not exceed 400° C.), overheating of the aerosol-generating substrate is not caused, and even the vaping experience may be greatly improved; moreover, the preheating time is greatly reduced, which greatly enhances the consumer's experience.

To provide a clearer understanding of the technical features, objectives, and effects of the present disclosure, detailed description of the present disclosure is described with reference to the accompanying drawings.

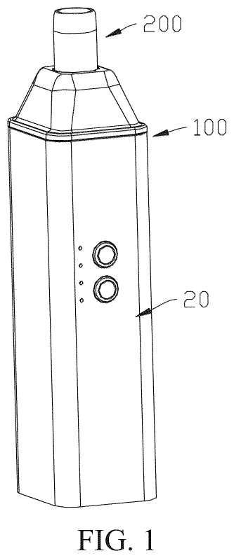

FIG. 1 shows a first embodiment of an aerosol-generating device according to the present disclosure. The aerosol-generating device 100 may heat an aerosol-generating substrate 200 in a low-temperature heat not burning manner, and has good atomization stability and experience. In some embodiments, the aerosol-generating substrate 200 may be inserted and removably provided on the aerosol-generating device 100 and may be cylindrical. Specifically, the aerosol-generating substrate 200 may be a solid material made of leaves and/or stems of plants in the form of strands or sheets, and aroma components may be further added to the solid material.

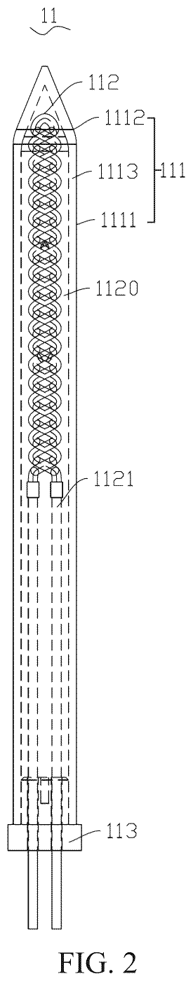

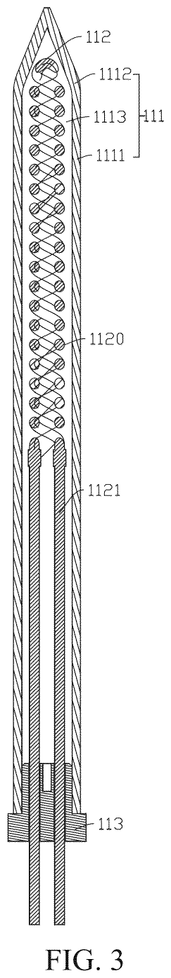

As shown in FIGS. 2 and 3, further, in this embodiment, the aerosol-generating device 100 includes a heating structure 11 which may be partially insertable into the aerosol-generating substrate 200, and a power supply assembly 20. Specifically, a portion thereof may be insertable into a substrate section of the aerosol-generating substrate 200 and generate an infrared light wave in an electrified state to heat the substrate section of the aerosol-generating substrate 200 and atomize same to form an aerosol. The heating structure 11 has the advantages of simple structure, high atomization efficiency, strong stability, and high service life. The power supply assembly 20 is used to supply power to the heating structure 11. Specifically, in some embodiments, the heating structure 11 may be removably mounted in a shell of the power supply assembly 20, and may be mechanically and/or electrically connected to a power supply in the power supply assembly 20. By detachably mounting the heating structure 11 in the shell of the power supply assembly 20, replacement of the heating structure 11 may be facilitated.

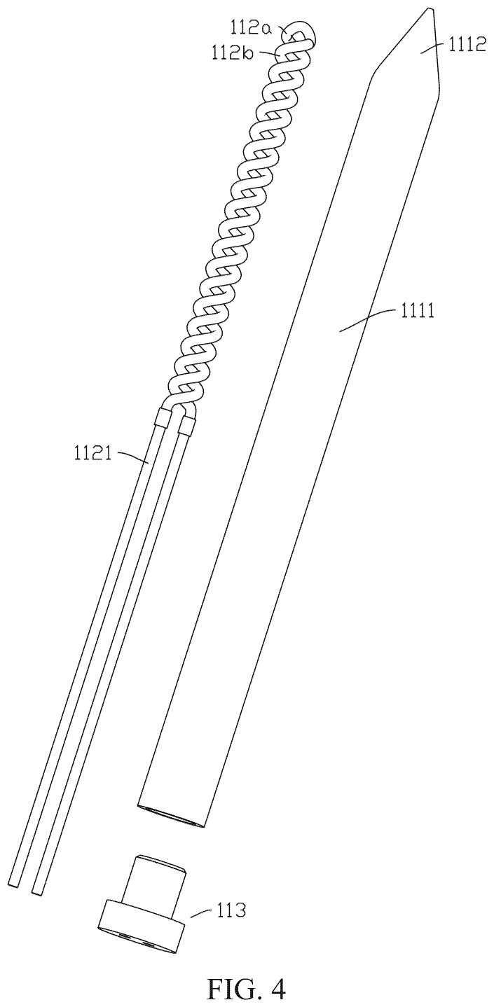

As shown in FIGS. 3 and 4, in this embodiment, the heating structure 11 includes a tube body 111, a heating element 112, and a base 113. The tube body 111 is at least partially covered on the heating element 112, and allows light waves to pass through to the aerosol-generating substrate 200. Specifically, in this embodiment, the tube body 111 allows infrared light waves to pass through, thereby facilitating the radiation of heat from the heating element 112 to heat the aerosol-generating substrate 200. Specifically, in this embodiment, an air gap is provided between the inner wall of the tube body 111 and the heating element 112, and in the electrified state, the heating element 1-3S rapidly heats up to about 1000° C., while the surface temperature of the tube body 111 may be controlled below 350° C., and an overall atomization temperature of the aerosol-generating substrate is controlled at 300 to 350° C., such that the aerosol-generating substrate is accurately atomized mainly in a waveband of from 2 to 5 μm. The base 113 is provided at an opening of the tube body 111 for mounting the tube body 111, and may preferably seal the opening of the tube body 111. The maximum operating temperature of the heating element of the present disclosure is between 500° C. and 1300° C., which is much higher than the maximum operating temperature of the heating elements in the prior art.

In this embodiment, the tube body 111 may be a quartz glass tube. Of course, it is to be understood that in some other embodiments, the tube body 111 is not limited to the quartz tube, but may be other window materials transparent to light waves, such as infrared transparent glass, transparent ceramic, diamond, etc.

In this embodiment, the tube body 111 has a hollow tubular shape. Specifically, the tube body 111 includes a tubular body 1111 having a circular cross-section, and an ogival structure 1112 provided at one end of the tubular body 1111. Of course, it is to be understood that in some other embodiments, the cross-section of the tubular body 111 is not limited to being circular. The tubular body 1111 is of a hollow structure having an opening at one end. The ogival structure 1112 is provided at an end of the tubular body 1111 away from the opening, whereby the ogival structure 1112 is provided to facilitate the heating structure 111 to be at least partially inserted into and removed from the aerosol-generating substrate 200. In this embodiment, the inner side of the tube body 111 is formed with a first accommodating cavity 1113, and the first accommodating cavity 1113 is a cylindrical cavity. In some other embodiments, the heating element 112 may alternatively be spaced apart on a periphery of the tube body 111, and a second accommodating cavity for accommodating the aerosol-generating substrate 200 may be formed inside the tube body 111.

In this embodiment, the tube wall of the tube body 111 is spaced apart from the entire heating element 112, and the spacing can be filled with air. Of course, it may be understood that in some other embodiments, the spacing may alternatively be filled with a reducing gas. By leaving the spacing, there is no direct contact between the tube body 111 and the heating element 112.

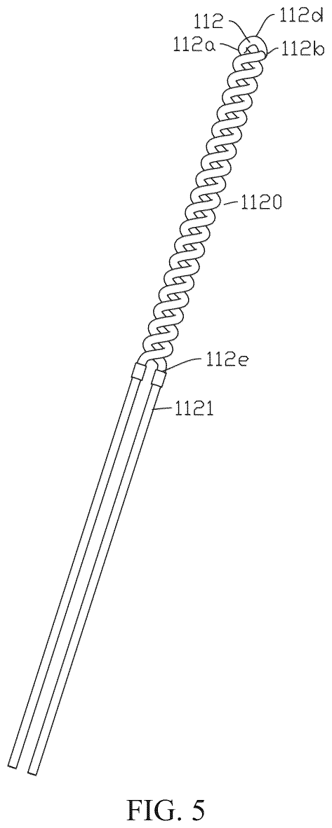

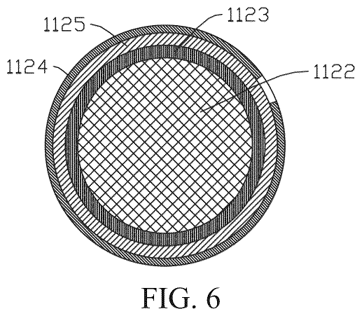

As shown in FIGS. 5 and 6, in this embodiment, the heating element 112 may be a single piece provided longitudinally, and may be wound to form a heating portion 1120 having a hollow spiral structure. Specifically, the heating element 112 may have a cylindrical shape as a whole, and may be wound to form a double spiral structure. Of course, it is to be understood that in some other embodiments, the heating element 112 is not limited to a single piece, but includes two or more pieces. The shape of the heating element 112 is not limited to being cylindrical, and in some embodiments, the shape of the heating element 112 may be sheet-like.

In this embodiment, the heating portion 1120 may be provided in the tube body 111 and spaced apart from the inner wall of the tube body 111 for generating an infrared light wave in an electrified state. Specifically, the infrared light waves may be passed through the tube body 111 to the aerosol-generating substrate 200.

In this embodiment, the heating portion 1120 includes a first heating portion 112a and a second heating portion 112b; one end of the first heating portion 112a and one end of the second heating portion 112b are connected; and the first heating portion 112a and the second heating portion 112b are wound to form a hollow double spiral structure. In this embodiment, the first heating portion 112a and the second heating portion 112b are integrally formed, and may be formed by bending a single elongated heating element 112. It is to be understood that in some other embodiments, the first and second heating portions 112a and 112b may be separate structures, and the first and second heating portions 112a and 112b may be two heating elements 112, respectively. Since the heating portion 1120 has a hollow structure, the risk of central conduction does not easily occur, the first heating portion 112a and the second heating portion 112b do not locally heat up, and the central heating element is not shielded by an external heating element, the heat transfer efficiency may be increased, and the heat utilization rate may be improved. A further advantage of the double spiral section is that a suitable resistance to rapid temperature rise may be ensured at a limited volume, which is particularly suitable for metal substrates.

In this embodiment, the heating portion 1120 includes a plurality of spiral sections 112c connected successively. In this embodiment, radial sizes of the respective spiral sections 112 c of the heating portion 1120 are provided to be equal. In some embodiments, the radial size of each spiral section 112c in the heating portion 1120 is not exactly the same or exactly the same. By adjusting the radial size of the spiral section 112c, the temperature field of the entire heating structure 11 may be configured. In this embodiment, a diameter of the heating element 112 may be from 0.05 to 0.7 mm. In some other embodiments, the radial size of a portion of the plurality of spiral sections 112c may be greater than that of another portion of the plurality of spiral sections 112c, e.g., the plurality of spiral sections 112c are configured such that the radial sizes of the spiral sections 112c provided at or near a middle portion are greater than those of the spiral sections 112c provided at or near the two ends, or the plurality of spiral sections 112c are configured such that the radial sizes of the spiral sections 112c provided at or near the middle portion are smaller than those of the spiral sections 112c provided at or near the two ends.

In this embodiment, the plurality of spiral sections 112c are equally distributed. Of course, it is to be understood that in some other embodiments, the multi-section spiral sections 112c are not limited to being equally distributed and may be distributed densely and sparsely alternately, sparsely first and then densely, densely first and then sparsely, sparsely first, then densely, and sparsely finally, and densely first, then sparsely, and densely finally, etc. In this embodiment, for a heating element made of the same material and with a uniform diameter, overall temperature field distribution may be controlled by adjusting distribution of a pitch among the spiral sections 112c, that is, the overall temperature field of the heating portion 1120 may be provided by the distribution of the pitch, so as to improve the stability of heating and improve the uniformity of atomization of the aerosol-generating substrate. It should be noted that, the overall temperature field distribution is related to the density of the multi-section spiral sections 112c, and the winding method with different density degrees of the spiral sections 112c may be selected according to the requirements of the temperature field distribution and the combustion state during the overall heating process of the aerosol-generating substrate.

In general, the smaller the pitch of the spirals, the greater the amount of heat generated by the same length, the higher the temperature, and the stronger the infrared radiation. However, for the two ends, since the heat dissipation area is larger than that of the middle portion, the temperature of the same pitch of the spiral is lower. To achieve the overall temperature uniformity, the spiral pitch of the two ends is smaller, and the spiral pitch of the middle portion is larger. However, the atomization effect of the aerosol-generating substrate 200 is not necessarily the best in the case of a uniform temperature field, but also combined with the influence of airflow, etc., and therefore different spiral structures may be provided to achieve temperature field control.

Of course, it is to be understood that in some other embodiments, the overall temperature field distribution may be controlled by controlling the resistance, and the resistance control may be performed by selecting the material of the heating element 112 or controlling different diameters, that is, selecting the heating element 112 with a corresponding material and a corresponding diameter according to requirements. In this embodiment, the resistivity may be controlled between 0.8 and 1.6 Ωmm²/m.

In this embodiment, the heating portion 1120 further includes a first end 112d and a second end 112e; the first end 112d may be provided opposite the second end 112e. The heating structure 11 further includes two conductive portions 1121, where the two conductive portions 1121 are respectively provided at a first end and a second end of the heating portion 1120, are respectively connected to the first heating portion 112a and the second heating portion 112b, extend in the same direction, may be led out from the same end of the tube body 111, and extend out from the base 113 to be conductively connected to the power supply assembly 20. In this embodiment, the conductive portion 1121 may be fixed to the first heating portion 112a and the second heating portion 112b by soldering to form a unitary structure. Of course, it is to be understood that in some other embodiments, the conductive portion 1121 may be integrally formed with the first and/or second heating portions 112a, 112b, and may be formed from the same heating element 112. In this embodiment, the conductive portion 1121 may be a lead wire, which may be soldered with the first and second heating portions 112a and 112b. Of course, it is to be understood that in some other embodiments, the conductive portion 1121 is not limited to being a lead wire, but may be other conductive structures. By arranging the conductive portion 1121 at one end of the heating portion 1120 and then leading out from the tube body 111, the assembly of the entire heating structure 11 may be facilitated, and the assembly process may be simplified. In the assembly, the heating structure 11 may be mounted on a support seat and then contacted with an electrode located in the support seat. Of course, it is to be understood that in some other embodiments, the conductive portions 1121 are not limited to a number of two, but may be one.

In this embodiment, the heating element 112 includes a heating substrate 1122 and an infrared radiation layer 1124. The heating substrate 1122 is capable of generating heat in an electrified state. The infrared radiation layer 1124 is provided on the outer surface of the heating substrate 1122. The heating substrate 1122 may excite the infrared radiation layer 1124 to generate infrared light waves and radiate out when the heating substrate is in an electrified heating state. In this embodiment, the heating substrate 1122 and the infrared radiation layer 1124 are provided in concentric circles in a cross section of the heating portion 1120.

In this embodiment, the heating substrate 1122 may have a strip shape as a whole, and a cross section thereof may have a circular shape. Specifically, the heating substrate 1122 may be a heating wire. Of course, it is to be understood that in some other embodiments, the heating substrate 1122 may not be limited to being cylindrical, but may be sheet-like, that is, the heating substrate 1122 may be a heating sheet. The heating substrate 1122 includes a metal substrate having high temperature oxidation resistance, which may be a metal wire. Specifically, the heating substrate 1122 may be a metallic material with good high-temperature oxidation resistance, high stability and low deformation, such as a nickel alloy substrate (e.g., nickel alloy wire) and an iron alloy substrate (e.g., iron alloy wire). In this embodiment, the heating substrate 1122 may have a radial size of from 0.15 to 0.8 mm.

In this embodiment, the heating element 112 further includes an oxidation-resistant layer 1123 formed between the heating substrate 1122 and the infrared radiation layer 1124. Specifically, the oxidation-resistant layer 1123 may be an oxide film, and the heating substrate 1122 is subjected to a high-temperature heat treatment to generate a dense oxide film on the surface thereof, where the oxide film forms the oxidation-resistant layer 1123. Of course, it is to be understood that in some other embodiments, the oxidation-resistant layer 1123 is not limited to including a self-formed oxide film, and in some other embodiments, it may be an oxidation-resistant coating applied to the outer surface of the heating substrate 1122. By forming the oxidation-resistant layer 1123, it is possible to ensure that the heating substrate 1122 is not heated or hardly oxidized in an air environment, thereby improving the stability of the heating substrate 1122, and thus there is no need to evacuate or fill the first accommodating cavity 1113 with a reducing gas, simplifying the assembly process of the entire heating structure 11, and saving manufacturing costs. In this embodiment, the thickness of the oxidation-resistant layer 1123 may be selected to be in a range of from 1 to 150 μm. When the thickness of the oxidation-resistant layer 1123 is less than 1 μm, the heating substrate 1122 is easily oxidized. When the thickness of the oxidation-resistant layer 1123 is more than 150 μm, the heat conduction between the heating substrate 1122 and the infrared radiation layer 1124 is affected.

In this embodiment, the infrared radiation layer 1124 may be an infrared layer. The infrared layer may be an infrared layer-forming substrate formed on a side of the oxidation-resistant layer 1123 away from the heating substrate 1122 under a high temperature heat treatment. In this embodiment, the infrared layer-forming substrate may be silicon carbide, spinel, or a composite-like substrate thereof. Of course, it is to be understood that in some other embodiments, the infrared radiation layer 1124 is not limited to being an infrared layer. In some other embodiments, the infrared radiation layer 1124 may be a composite infrared layer, which may be a composite of an infrared layer-forming substrate and a bonding material for bonding with the oxidation-resistant layer 1123. Specifically, the bonding material may be a glass powder and the composite infrared layer may be a glass powder composite infrared layer. In this embodiment, the infrared layer may be dip-coated, spray-coated, brushed, etc. onto a side of the oxidation-resistant layer 1123 away from the heating substrate 1122. The thickness of the infrared radiation layer 1124 may be from 10 to 300 μm. When the thickness of the infrared radiation layer 1124 is from 10 to 300 μm, the effect of the infrared light wave is better, such that the atomization efficiency and the atomization experience of the aerosol-generating substrate 200 are better. Of course, it is to be understood that in some other embodiments, the thickness of the infrared radiation layer 1124 is not limited to 10 to 300 μm.

The heating element 112 further includes a bonding layer 1125 provided between the oxidation-resistant layer 1123 and the infrared radiation layer 1124, and the bonding layer 1125 may be used to prevent a local breakdown of the heating substrate 1122 and further improve a bonding force between the oxidation-resistant layer 1123 and the infrared radiation layer 1124. In some embodiments, the bonding material in the bonding layer 1125 may be glass powder, that is, the bonding layer 1125 may be a layer of glass powder.

In this embodiment, the outer wall of the heating element 112 may be provided with an insulating structure as a whole, that is, the outer walls of the first heating portion 112a and the second heating portion 112b may be provided with an insulating structure. Of course, it is to be understood that the insulating structure may be provided only on the outer wall of the first heating portion 112a or the outer wall of the second heating portion 112b. By providing the insulating structure, it is possible to provide insulation between the first heating portion 112a and the second heating portion 112b. In this embodiment, the insulating structure may be an air gap, which may be formed by vaporizing an insulating coating layer provided between the first heating portion 112a and the second heating portion 112b. In this embodiment, the insulating coating may be applied to the outer surface of the first heating portion 112a and the outer surface of the second heating portion 112b, and it is to be understood that in some other embodiments, the insulating coating may be applied to only the outer surface of the first heating portion 112a or the outer surface of the second heating portion 112b. In some other embodiments, the insulating structure may simply be an insulating layer applied to the outer surface of the first heating portion 112a and/or the second heating portion 112b, which does not require vaporization treatment.

In some embodiments, the insulating coating may be vaporized at a high temperature such that an air gap is formed between the first heating portion 112a and the second heating portion 112b, thereby providing insulation. In this embodiment, the insulating coating may be made of Teflon. Specifically, the outer surface of the heating element 112 may be coated with Teflon as a whole, and then tightly wound into a spiral shape, such that there is a Teflon coating layer with two wall thicknesses between the first heating portion 112a and the second heating portion 112b, and the heating portion 1120 is wound backwards, and high temperature may vaporize the Teflon, thereby forming an air gap between the first heating portion 112a and the second heating portion 112b, so as to be insulated by the air gap.

It is to be understood that in some other embodiments, the insulating structure is not limited to being an insulating coating, and in some other embodiments, the insulating structure may be an insulating tube body that may be sleeved over the periphery of the second heating portion 112b to prevent the second heating portion 112b from directly contacting the first heating portion 112a, resulting in local conduction or breakdown. Of course, it is understood that the insulating tube body may be sleeved over the periphery of the first heating portion 112a, and the insulating tube body may be a ceramic tube, a glass tube, or other high-temperature-resistant insulating material.

In some embodiments, the oxide layer 1123 formed on the outer surface of the heating substrate 1122 of the first heating portion 112a and the second heating portion 112b through heat treatment can also enhance the insulation of the first heating portion 112a and the second heating portion 112b, thereby protecting the heating substrate 1122. That is, the insulating structure may also include the oxide layer 1123.

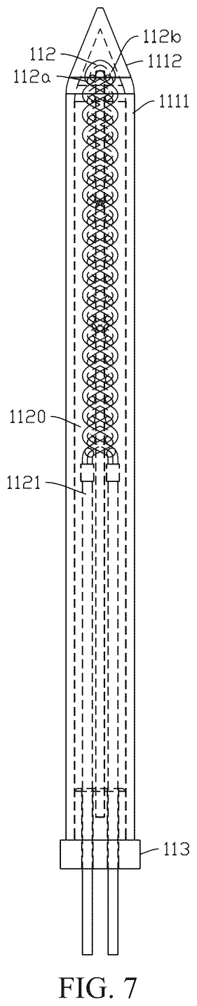

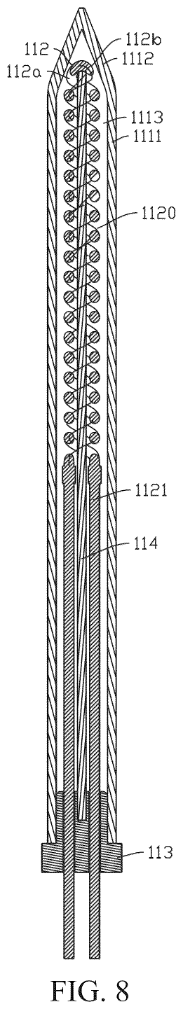

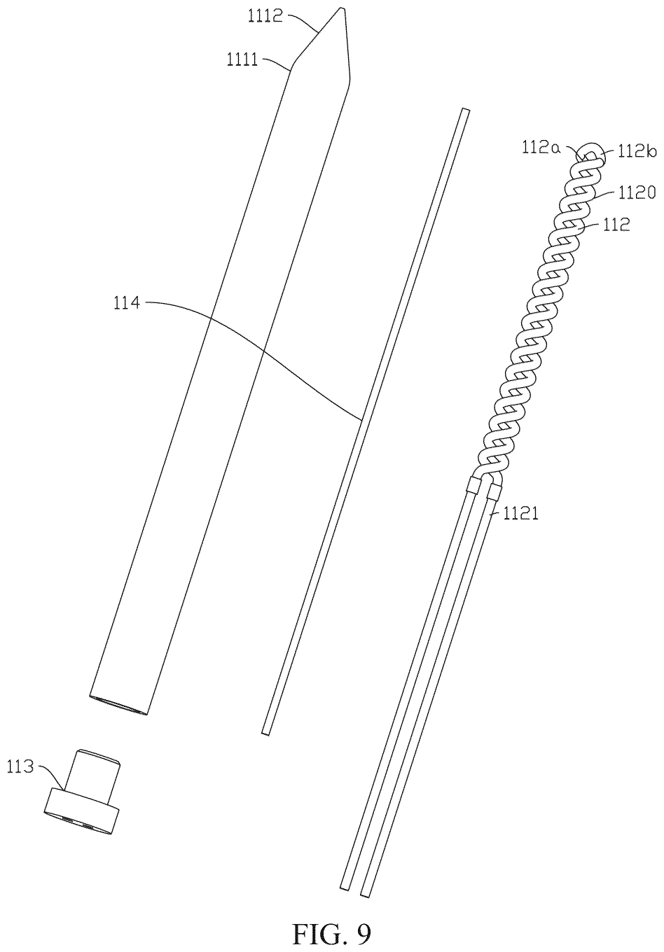

FIGS. 7 to 9 show a second embodiment of the aerosol-generating device of the present disclosure, which differs from the first embodiment in that the heating structure further includes a support rod 114, which is an insulating rod, and the support rod 114 may partially extend into the heating portion 1120, is located at the center of the heating portion 1120, and may be insulated from the heating portion 1120, and may serve as a support for the heating portion 1120. The support rod 114 may be cylindrical, and the support rod 114 may be inserted into the base 113 for fixation. By providing the support rod 114, the heating portion 1120 of a pot cover may be supported, so as to ensure that the heating element 112 is not completely deformed by heating, thereby ensuring that the gap between the heating element 112 and the tube body 111 is uniform, and thus ensuring that a temperature field may be kept uniform. It is to be understood that in some other embodiments, the support rod 114 may be omitted.

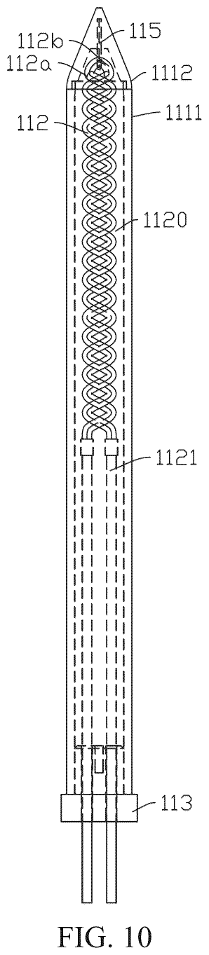

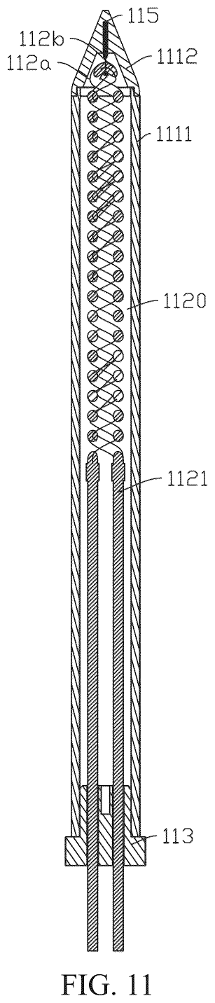

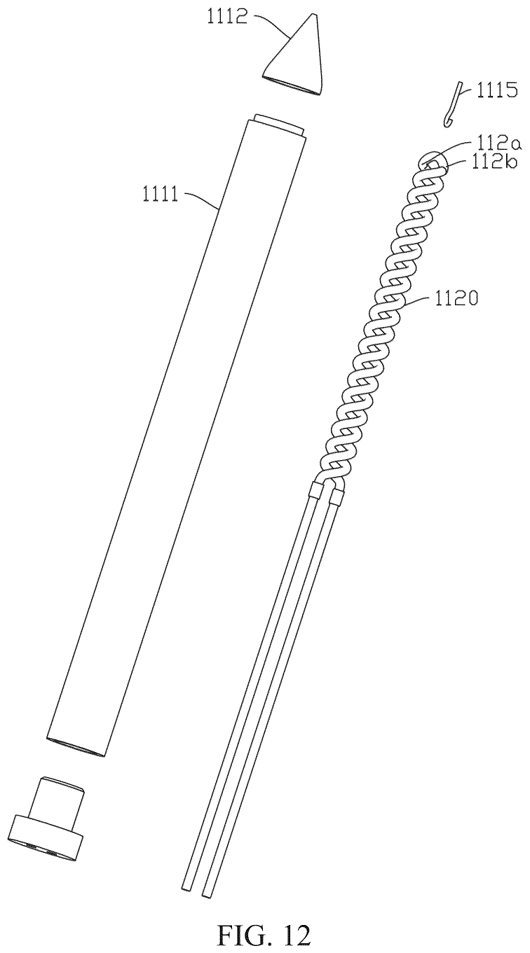

FIGS. 10 to 12 show a third embodiment of an aerosol-generating device according to the present disclosure, which differs from the first embodiment in that a fixing structure 115 for fixing the heating portion 1120 is provided in the tube body 111. In this embodiment, the fixing structure 115 may be provided in the ogival structure 1112, and the fixing structure 115 may be fixedly provided or removably attached to the ogival structure 1112. In this embodiment, the fixing structure 115 may be a hook, which may be configured at a bending portion of the heating element 112, and then fix the heating portion 1120, such that the gap between the heating element 112 and the inner wall of the tube body 111 is uniform, and the overall temperature field of the heating structure 11 is uniform. Of course, it is to be understood that in some other embodiments, the fixing structure 115 may not be limited to being a hook, and may not be limited to being provided in the ogival structure 1112. In this embodiment, the ogival structure 1112 may be removably attached to the tubular body 1111, such as by sleeving or screwing the tubular body 1111. Of course, it is to be understood that in some other embodiments, the ogival structure 1112 may be integrally formed with the tubular body 1111.

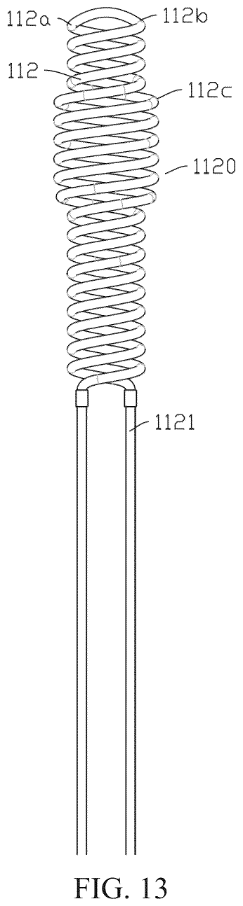

FIG. 13 shows a fourth embodiment of the aerosol-generating device of the present disclosure, which differs from the first embodiment in that in the heating portion 1120, the plurality of spiral sections 112c are configured such that the radial sizes of the spiral sections 112c provided at or near a middle portion are greater than those of the spiral sections 112c provided at or near the two ends, and by adjusting the radial sizes of the spiral sections 112c, the overall temperature field of the heating structure 11 may be configured.

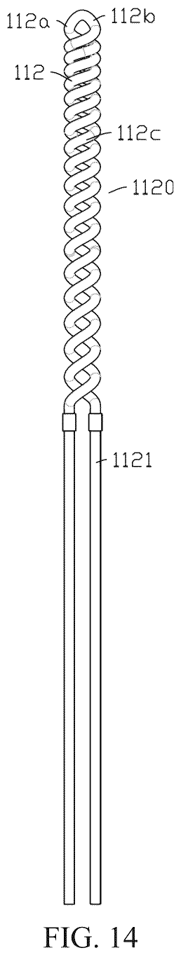

FIG. 14 shows a fifth embodiment of the aerosol-generating device of the present disclosure, which differs from the first embodiment in that the plurality of spiral sections 112c are distributed densely first and then sparsely, and the temperature field may be controlled by adjusting the pitch of the spiral sections 112c.

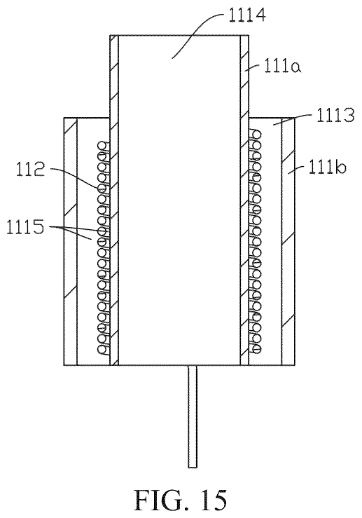

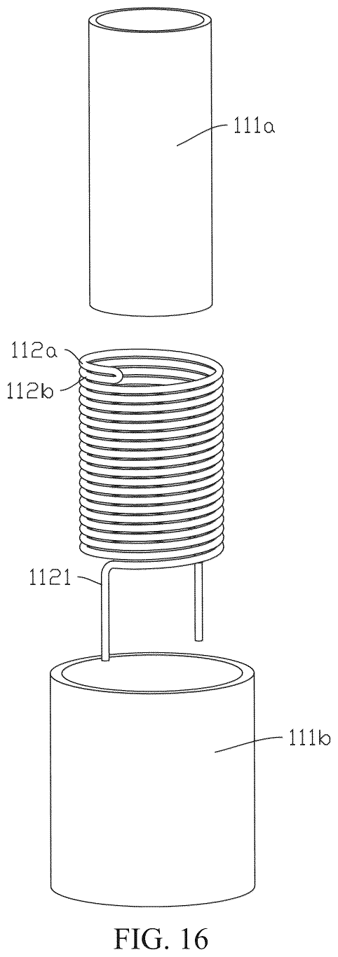

FIGS. 15 and 16 show a sixth embodiment of an aerosol-generating device according to the present disclosure, which differs from the first embodiment in that the heating structure 11 is not limited to being partially inserted into the aerosol-generating substrate 200 to heat the aerosol-generating substrate 200. In this embodiment, the heating structure 11 may be sleeved over the periphery of the substrate section of the aerosol-generating substrate 200, and the aerosol-generating material in the aerosol-generating substrate 200 is heated by means of circumferential heating. In this embodiment, the second heating portion 112b may be omitted.

In this embodiment, the tube body 111 includes a first tube body 111a and a second tube body 111b; the first tube body 111a has a hollow structure in which both ends pass through. The first tube body 111a may have a cylindrical shape, and an inner diameter thereof may be slightly larger than an outer diameter of the aerosol-generating substrate 200. A second accommodating cavity 1114 may be formed at the inner side of the first tube body 111a for heating the substrate section of the aerosol-generating substrate 200. An axial length of the first tube body 111a may be greater than that of the second tube body 111b. The second tube body 111b may be sleeved over the periphery of the first tube body 111a, the second tube body 111b may have a cylindrical shape, the radial size of the second tube body 111b may be greater than that of the first tube body 111a, that is, a spacing may be provided between the second tube body 111b and the first tube body 111a and may form a first accommodating cavity 1113 configured for accommodating the heating element 112. In some embodiments, the heating element 112 is provided around the periphery of the first tube body 111a, and an air gap 1115 is left between the inner wall of the second tube body 111b and the outer wall of the first tube body 111a, such that the inner wall of the first accommodating cavity 1113 forms a certain temperature difference with the heating element 112, thereby playing a role of thermal insulation. In some embodiments, the inner wall of the second tube body 111b may be provided with a reflective layer for reflecting the heat of the heating element 112 and radiating the heat to the aerosol-generating substrate 200 to enhance the heating energy efficiency.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating structure, comprising:
a heating portion; and
two conductive portions,
wherein the heating portion has a spiral structure and is formed by winding at least one heating element, the at least one heating element comprises a heating substrate configured to generate heat in an electrified state, an infrared radiation layer being provided on an outer surface of the heating substrate and configured to radiate infrared light waves,
wherein the heating portion comprises a first end and a second end provided opposite to the first end, and
wherein the two conductive portions are connected to the first end and the second end of the heating portion, respectively, and extend in a same direction.

2. The heating structure of claim 1, wherein the heating portion has a double spiral structure.

3. The heating structure of claim 1, wherein the heating portion comprises a first heating portion and a second heating portion,
wherein one end of the first heating portion and one end of the second heating portion are connected and wound into a double spiral structure, and
wherein the two conductive portions are connected to other ends of the first heating portion and the second heating portion, respectively.

4. The heating structure of claim 1, wherein the heating portion comprises a plurality of spiral sections connected successively.

5. The heating structure of claim 4, wherein radial sizes of spiral sections of the heating portion are equal.

6. The heating structure of claim 4, wherein radial sizes of the plurality of spiral sections are not completely equal or not equal at all.

7. The heating structure of claim 6, wherein the plurality of spiral sections are configured such that radial sizes of the spiral sections provided at or near a middle portion are greater than those of the spiral sections provided at or near the two ends.

8. The heating structure of claim 6, wherein the plurality of spiral sections are configured such that radial sizes of the spiral sections provided at or near the middle portion are smaller than those of the spiral sections provided at or near the two ends.

9. The heating structure of claim 4, wherein the plurality of spiral sections are distributed at equal intervals.

10. The heating structure of claim 4, wherein the plurality of spiral sections are distributed densely and sparsely, alternately.

11. The heating structure of claim 4, wherein the plurality of spiral sections are distributed sparsely first and then densely.

12. The heating structure of claim 4, wherein the plurality of spiral sections are distributed densely first and then sparsely.

13. The heating structure of claim 4, wherein the plurality of spiral sections are distributed sparsely first, then densely, and finally sparsely.

14. The heating structure of claim 4, wherein the plurality of spiral sections are distributed densely first, then sparsely, and finally densely.

15. The heating structure of claim 1, wherein the heating element is provided longitudinally, and
wherein the first heating portion and the second heating portion are formed by bending.

16. The heating structure of claim 1, further comprising:
a support rod partially extending into the heating portion and insulated from the heating portion so as to support the heating portion.

17. The heating structure of claim 1, further comprising:
a base,
wherein the two conductive portions extend out of the base.

18. The heating structure of claim 1, further comprising:
a tube body configured to allow infrared light waves generated by the heating portion to pass through,
wherein the heating element is provided at least partially spaced apart from the tube body.

19. The heating structure of claim 18, wherein a fixing structure for fixing the heating portion is provided on the tube body.

20. The heating structure of claim 18, wherein the tube body has a hollow tubular shape and is formed with a first accommodating cavity therein for accommodating the heating element.

21. The heating structure of claim 18, wherein the heating elements are spaced apart on a periphery of the tube body, and
wherein the tube body is hollow inside and is formed therein with a second accommodating cavity for accommodating an aerosol substrate.

22. The heating structure of claim 18, wherein the tube body comprises a first tube body configured to allow light waves to pass through and a second tube body sleeved over a periphery of the first tube body,
wherein a spacing is provided between the second tube body and the first tube body, the spacing forming a first accommodating cavity accommodating the heating portion, and
wherein the second accommodating cavity for heating an aerosol-generating substrate is formed inside the first tube body.

23. The heating structure of claim 22, wherein an air gap is provided between at least a part of the heating element and an inner wall of the second tube body and/or an outer wall of the first tube body.

24. The heating structure of claim 18, wherein the heating element is spaced apart from tube wall of the tube body as a whole.

25. The heating structure of claim 18, wherein the heating element is not provided in direct contact with the tube body.

26. The heating structure of claim 18, wherein a tube wall of the tube body has a thickness of from 0.15 to 0.6 mm.

27. The heating structure of claim 18, wherein a pitch between a tube wall of the tube body and the heating element is from 0.05 to 1 mm.

28. An aerosol-generating device, comprising:
the heating structure of claim 1.
